(19) United States
(12) Patent Application Publication
(10) Pub. No.: US 2009/0067160 A1
(43) Pub. Date: Mar. 12, 2009

(54) ELECTRIC LIGHT BODY

(76) Inventor: Bernard Cook, Cheltenham (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/299,709

(22) PCT Filed: Apr. 18, 2007
(86) PCT No.: PCT/GB2007/001392

§ 371 Date: Nov. 5, 2008

(30) Foreign Application Priority Data
May 8, 2006 (GB) 0609043.5

(51) Int. Cl. F21V 21/088; A47B 97/00

(52) U.S. Cl. 362/133; 362/396

(57) ABSTRACT

An electric light body (10) comprises a body element (12) for location within the depth of a shelf (46) and which has a cavity (22) for receiving one light emitting element, a first clamp element (14) which has a first flange (38) for contacting a first surface (52) of the shelf (46) and a first opening (36) and which is releasably engagable with the body element (12) at or adjacent to one end thereof, a second clamp element (16) which is independent of the first clamp element (14) and which has a second flange (38) for contacting a second surface (54) of the shelf (46) opposite the first surface (52) and a second opening (36) and which is releasably engagable with the body element (12) at or adjacent to another end of the body element (12) opposite the said one end, a first cover element (18) on the first clamp element (14) for covering the said one end of the body element (12), and a second cover element (20) on the second clamp element (16) for covering the said other end of the body element (12). At least one of cover elements (18, 20) allows light from the light emitting device to pass therethrough.

This invention relates to the body of an electric light which can be clamped in or substantially in the depth of a shelf.

It is known to provide lights in display stands and cabinets. However, these known lights usually project down from the upper surface of the cabinet or are concealed behind a depending lip or bead, and only provide a uni-directional, typically downwardly directed, beam of light. There is a need for a light that will fit entirely within the thickness of a traditional shelf of furniture, such as a bookcase, and which will provide at least the option of multi-directional, typically being both upwards and downwards, lighting.

According to a first aspect of the present invention, there is provided an electric light body for clamping to, and which is positionable in a depth of, a shelf, the light body comprising: a body element for location at least within the depth of the shelf and having a cavity for receiving at least one light emitting device; a first clamp element which is releasably engagable with the body element at or adjacent to one end thereof and which has a first flange for contacting a first surface of the shelf and a first opening for receiving the said one end of the body element; a second clamp element which is independent of the first clamp element, which is releasably engagable with the body element at or adjacent to another end of the body element opposite the said one end, and which has a second flange for contacting a second surface of the shelf opposite the first surface and a second opening for receiving the said other end of the body element; a first cover element on the first clamp element for covering the said one end of the body element; and a second cover element on the second clamp element for covering the said other end of the body element, at least one of the first and second cover elements being formed from light-transmissible material to in use allow light from the said at least one light emitting device to pass therethrough.

Preferable and/or optional features of the first aspect of the invention are set forth in claims 2 to 13, inclusive.

According to a second aspect of the invention, there is provided a shelf having an electric light body in accordance with the first aspect of the invention, the light body being received within the depth of the shelf and being held in place by the first and second flanges of the first and second clamp elements clamping against opposite surfaces of the shelf.

Preferably, the first and second flanges and/or the first and second cover plates lie flush or substantially flush with the respective surfaces of the shelf.

According to a third aspect of the invention, there is provided an article of furniture having a shelf in accordance with the second aspect of the invention.

Preferably, the article of furniture is a cupboard, cabinet, dresser, and/or a bookcase.

The invention will now be more particularly described, by way of example only, with reference to the accompanying drawings, in which:

FIG. 1 is a perspective view of an electric light body, in accordance with the first aspect of the present invention;

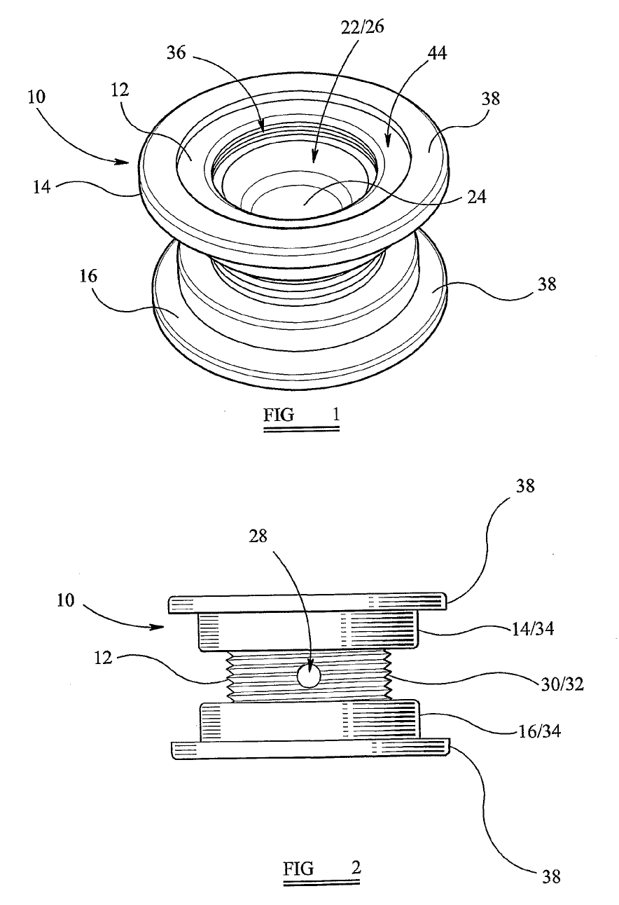

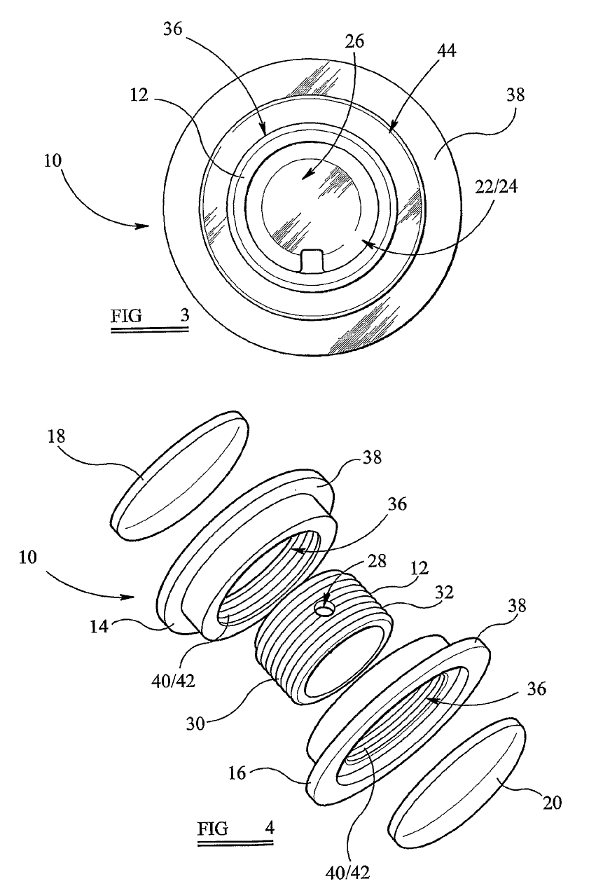

FIG. 2 is an elevational side view of the electric light body;

FIG. 3 is a plan view of the electric light body;

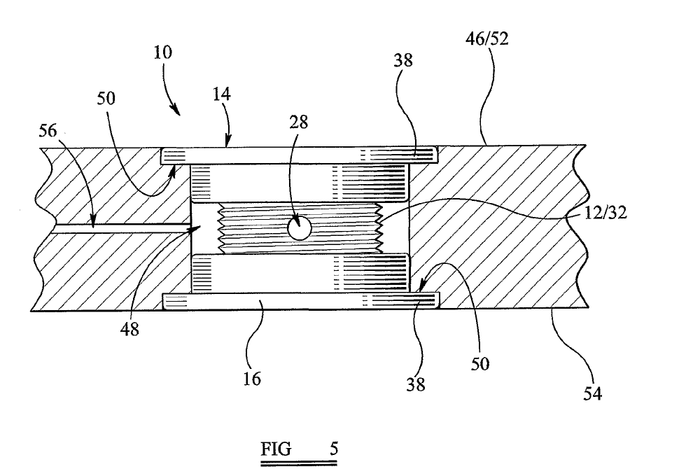

FIG. 4 is an exploded view of the electric light body; and

FIG. 5 is a cross-sectional view of a shelf of an article of furniture, in accordance with the second aspect of the invention, in which the electric light body is received.

Referring firstly to FIGS. 1 to 4 of the drawings, there is provided an electric light body 10 which is typically formed from plastics and/or metal and which comprises a body element 12, first and second independent clamp elements 14, 16, and first and second cover plates 18, 20 (see FIG. 4).

The body element 12 is cylindrical and includes a cavity 22 in which can be received an electric circuit and one or more light emitting devices, such as LEDs. In the present case, the body element 12 includes a partition wall 24 midway or substantially midway between its ends, thus dividing the cavity 22 into two secondary cavities 26 in which respective electric circuits and/or light emitting devices (not shown) can be positioned.

A cable opening 28 is formed through a side wall 30 of the body element 12, midway or substantially midway between the ends of the body element 12, so that an electrical cable can be passed into the cavity 22 to energise the or each light emitting device.

A single continuous screw-thread 32 is also formed on the exterior surface of the body element 12, from one end of the body element 12 to the other end.

Each independent clamp element 14, 16 is formed in the shape of an endless ring, and comprises a hub 34 which defines an opening in the form of an aperture 36, and a radially outwardly projecting endless circular flange 38 positioned at one end of the hub 34. A bore 40 of the aperture 36 has a continuous screw-thread 42 formed from one end of the bore 40 to the other end.

An outside diameter of the body element 12 matches or substantially matches an internal diameter of each aperture 36, so that the body element 12 and the first and second clamp elements 14, 16 can be screw-threadingly engaged with each other.

A circular recess 44 is formed in one end of each clamp element 14, 16, between the bore 40 of the aperture 36 and the flange 38, so that a transition from the flange 38 to the bore 40 is stepped.

The first and second cover plates 18, 20 are solid disk-shaped elements. Each cover plate 18, 20 can be selected from a range of cover plates, with the range varying from fully opaque cover plates to fully transparent cover plates, and including other types of light transmissible plates, such as translucent plates and light-diffusing plates.

A depth and diameter of each circular recess 44 of each clamp element 14, 16 matches or substantially matches a thickness and diameter of each cover plate 18, 20.

Referring to FIG. 5, to locate an electric light body 10 in a shelf 46, a circular hole 48 is initially formed through a depth of the shelf 46. A diameter of the circular hole 48 corresponds closely to an outside diameter of each hub 34 of each clamp element 14, 16. A circular recess 50 to accommodate the flange 38 of each clamp element 14, 16 is formed in the upper and lower major surfaces 52, 54 of the shelf 46, adjacent to the circular hole 48. The depth of the circular recess 50 in the shelf 46 is sufficient to allow each flange 38 of each clamp element 14, 16 to lie flush with the respective major surface 52, 54 of the shelf 46 surrounding the light body 10.

A cover plate 18, 20 is selected for each clamp element 14, 16, and is positioned in the circular recess 44 of the respective clamp element 14, 16. Each cover plate 18, 20 is held in place by suitable fastening means, such as bonding. However, the fastening means can be in the form of press fit engagement, snap fit engagement, or via one or more, typically countersunk, threaded fastening devices.

With the or each electric circuit and light emitting device located in the or each secondary cavity 26 of the body element 12, the first clamp element 14 is screw-threadingly engaged with the body element 12 so that the cover plate 18 covers the adjacent end of the body element 12. The interengaged parts are then positioned in the circular hole 48 and one of the circular recesses 50 formed in shelf 46.

The second clamp element 16 with attached cover plate 20 is then located adjacent to the other circular recess 50 of the shelf 46, and is screw-threadingly engaged with the other end of the body element 12 until the flange 38 is received flush in the other circular recess 50 of the shelf 46. The cover plate 20 thus similarly covers the other end of the body element 12 to which it is adjacent to.

In this manner, the light body 10 is clamped, via the respective flanges 38 of the clamp elements 14, 16, in position within or substantially within the depth of the shelf 46.

The electrical cable running to the light body 10 is either positioned in a channel formed in one of the upper and lower major surfaces 52, 54 of the shelf 46, or, as shown in FIG. 5, is fed along a narrow elongate hole 56 formed in the depth of the shelf 46 between the upper and lower major surfaces 52, 54 of the shelf 46. The latter case is advantageous, since the cable is fully hidden from view without resulting in damage to the exterior appearance of the shelf 46.

When utilising two light-transmissible cover plates 18, 20, light can be emitted from the in use light body 10 in two opposite directions, thus providing illumination in two, typically upwards and downwards, directions.

When one opaque cover plate and one light-transmissible cover plate are selected, light will be emitted from the light body 10 in only one direction, typically either upwards or downwards.

Although it is the intention that the cover plates, along with the flanges, define opposite extremities of the light body, the cover plates could be recessed slightly relative to the flanges, or vice versa.

The shelf is typically part of an article of furniture, such as a cupboard, cabinet, dresser, and/or a bookcase.

Due to the body element being independent of the first and second clamp elements, the size of the body element can be easily adapted to different shelf depths, without requiring alteration of the clamp elements.

Although a single continuous screw-thread is formed on the exterior surface of the body element, two spaced screw-threads can be formed originating from opposite ends of the body element.

Furthermore, although it is preferable to recess the flanges in the shelf, so that the clamp elements lie flush with the major surfaces of the shelf, the flanges need not be recessed. Since the flanges are not particularly thick, the clamp elements and consequently the cover plates will stand slightly proud of the shelf surfaces, and thus be only substantially flush. However, this is unlikely to be particularly noticeable. To further mitigate this potential problem, clamp elements having reduced thicknesses flanges can be provided.

The electric circuit can be adapted to selectively energise one or more of the light emitting devices so that, even when utilising two light-transmissible cover plates, a user can selectively energise the light emitting devices to provide a light beam in only one direction or in both opposite directions simultaneously.

It will be understood that, although cover plates are described above, any suitable cover element can be utilised. For example, the cover elements can be formed integrally with the clamp element, rather than being separate elements. In this case, at least one of the clamp elements and cover elements are formed from a one-piece moulding of light-transmissible plastics material. In the event of the cover elements being integral with the clamp elements, the apertures of the clamp elements described above are dispensed with and become recesses.

Although the electric body can advantageously be entirely accommodated within or substantially within the depth of a shelf, so that it lies flush or substantially flush with the major surfaces of the shelf, it is envisaged that one or both cover elements can be or include ornamental projections, such as bookends and vase shapes, to produce an aesthetic effect. In this case, the projection is either produced entirely or partly from fully light-transmissible material, or includes apertures to allow light to shine therefrom.

It is thus possible to provide an electric light body which is easily and cheaply adaptable to varying depths of furniture shelf. It is also possible to provide a shelf light which provides the option of lighting in one direction or in two opposite directions simultaneously. Furthermore, the manner of fixing the light body to the shelf by clamping is simple and, since the light body is received entirely or substantially entirely within the depth of the shelf and therefore lies flush with the shelf surfaces, unobtrusive. The electric light body can be a three part, four part or five part device, depending whether one or both cover elements are formed integrally with the clamp elements.

The embodiments described above are given by way of examples only, and various other modifications will be apparent to persons skilled in the art without departing from the scope of the invention, as defined by the appended claims.

1. An electric light body (10) for clamping to, and which is positionable in a depth of, a shelf (46), the light body (10) comprising: a body element (12) for location at least within the depth of the shelf (46) and having a cavity (22) for receiving at least one light emitting device; a first clamp element (14) which is releasably engagable with the body element (12) at or adjacent to one end thereof and which has a first flange (38) for contacting a first surface (52) of the shelf (46) and a first opening (36) for receiving the said one end of the body element (12); a second clamp element (16) which is independent of the first clamp element (14), which is releasably engagable with the body element (12) at or adjacent to another end of the body element (12) opposite the said one end, and which has a second flange (38) for contacting a second surface (54) of the shelf (46) opposite the first surface (52) and a second opening (36) for receiving the said other end of the body element (12); a first cover element (18) on the first clamp element (14) for covering the said one end of the body element (12); and a second cover element (20) on the second clamp element (16) for covering the said other end of the body element (12), at least one of the first and second cover elements (18, 20) being a light-transmissible element to in use allow light from the said at least one light emitting device to pass therethrough.

2. An electric light body (10) as claimed in claim 1, wherein the body element (12) includes a single screw-thread (32) integrally formed thereon, and the first and second clamp elements (14, 16) each include a mating screw-thread by which the first and second clamp elements (14, 16) are engaged or engagable with the body element (12).

3. An electric light body (10) as claimed in claim 1, wherein the first and second openings (36) of the first and second clamp elements (14, 16) are apertures, and the first and second cover elements (18, 20) are separate of the first and second clamp elements (14, 16) and are, in use, supported by the first and second clamp elements (14, 16), respectively, to cover the respective apertures.

4. An electric light body (10) as claimed in claim 1, wherein the first and second openings (36) of the first and second clamp elements (14, 16) are recesses, and the first and second cover elements (18, 20) are integral with the first and second clamp elements (14, 16).

5. An electric light body (10) as claimed in claim 1, wherein the first and second cover elements (18, 20) are light-transmissible cover elements, so that light can be emitted from the in use light body (10) in two opposite directions.

6. An electric light body (10) as claimed in claim 1, wherein at least one of the first and second cover elements (18, 20) is a planar plate-shaped element.

7. An electric light body (10) as claimed in claim 1, wherein at least one of the first and second cover elements (18, 20) is or includes an ornamental projection through which light can pass to produce an aesthetic effect.

8. An electric light body (10) as claimed in claim 1, wherein the body element (12) includes a cable opening (28) through which an electric cable can pass in order to supply electricity to the said at least one light emitting device.

9. An electric light body (10) as claimed in claim 8, wherein the cable opening (28) is formed in a side of the body element (12), partway between its ends, so that the electric cable can be located within the depth of the shelf (46).

10. An electric light body (10) as claimed in claim 1, wherein the body element (12) is cylindrical.

11. An electric light body (10) as claimed in claim 1, wherein the first and second clamp elements (14, 16) are circular.

12. An electric light body (10) as claimed in claim 1, wherein the first and second cover elements (18, 20) define opposite extremities of the light body (10).

13. An electric light body (10) as claimed in claim 1, wherein the first and second flanges (38) define opposite extremities of the light body (10).

14. (canceled)

15. A shelf (46) having an electric light body (10) as claimed in claim 1, the light body (10) being received in the depth of the shelf (46) and being held in place by the first and second flanges (38) of the first and second clamp elements (14, 16) clamping against opposite surfaces (52, 54) of the shelf (46).

16. A shelf (46) as claimed in claim 15, wherein the first and second flanges (38) and/or the first and second cover elements (18, 20) lie flush or substantially flush with the respective surfaces (52, 54) of the shelf (46).

17. An article of furniture having a shelf (46) as claimed in claim 15.

18. An article of furniture as claimed in claim 17, wherein the article of furniture is a cupboard, cabinet, dresser, and/or a bookcase.
